(19) United States
(12) Patent Application Publication
(10) Pub. No.: US 2007/0290517 A1
(43) Pub. Date: Dec. 20, 2007

(54) Non-Contact Transport Apparatus

(75) Inventors: Shigekazu Nagai, Tokyo (JP); Akio Saitoh, Koshigaya-shi (JP); Masahiko Someya, Ryugasaki-shi (JP); Masaru Saitoh, Joso-shi (JP); Yukihisa Yoshida, Moriya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC KABUSHIKI KAISHA, Tokyo (JP)

(21) Appl. No.: 11/754,964

(22) Filed: May 29, 2007

(30) Foreign Application Priority Data
Jun. 2, 2006 (JP) 2006-154398

(51) Int. Cl. B65H 29/00; B65G 49/07

(52) U.S. Cl. 294/64.1

(57) ABSTRACT

A non-contact transport apparatus comprises a top plate with a supply port for supplying air thereto, a diffuser plate having a plurality of discharge holes for discharging air, and a sheet-shaped nozzle plate interposed between the top plate and the diffuser plate and having a plurality of nozzles therein. The top plate, the nozzle plate and the diffuser plate are stacked and integrally connected to one another through a plurality of connecting bolts. Air is supplied from the supply port and via flow passages to the plurality of nozzles. Air is directed to the outside from the plurality of discharge holes, via radially formed nozzles oriented in a radially outward direction.

### BACKGROUND OF THE INVENTION

1. Field of the Invention

The present invention relates to a non-contact transport apparatus capable of holding and transporting a workpiece in a non-contact state.

2. Description of the Related Art

A non-contact transport apparatus has hitherto been known, which is capable of transporting a semiconductor wafer or other workpiece in a non-contact manner utilizing the Bernoulli effect generated by the flow of a gas. The workpiece may be composed of a sheet-shaped part for constructing a display device, such as a liquid crystal or a plasma display.

For example, as disclosed in Japanese Laid-Open Patent Publication No. 2002-64130, such a non-contact transport apparatus includes, for example, a recess having an inner circumferential surface with a circumferential shape, a flat surface formed on a side of an opening of the recess which is opposed to a workpiece, and a fluid passage that discharges a supply fluid into the recess by means of jetting ports disposed so as to face the inner circumferential surface of the recess. Air flow having a high velocity flows between the flat surface and the workpiece as a result of air supplied from a fluid inlet port. Accordingly, a negative pressure is generated by the Bernoulli effect to lift the workpiece, and a high velocity air flow having a positive pressure, which flows between the flat surface and the workpiece, is used to maintain the workpiece and the flat surface in a non-contact manner so as to transport the workpiece.

Japanese Laid-Open Patent Publication No. 10-181879 discloses a transport apparatus provided with a transport head having a curved gas guide surface. In this transport apparatus, air is discharged from nozzles toward the gas guide surface, and thus a negative pressure is generated on the front surface of the transport head by means of air that flows radially along the gas guide surface. The workpiece is held by the transport head by utilizing such negative pressure, whereby transport of the workpiece is performed.

In the conventional technique disclosed in Japanese Laid-Open Patent Publication No. 2002-64130, for example, when a large-sized sheet-shaped workpiece, such as a plasma display, is held, the non-contact transport apparatus must also be large in size depending on the shape of the workpiece. However, as the apparatus is large in size, it is difficult to secure a uniform holding force over the entire surface of the workpiece. Thus, it is feared that strains may be generated on the workpiece, making it impossible to obtain a desired product quality.

The non-contact transport apparatus described in Japanese Laid-Open Patent Publication No. 2002-64130 is constructed such that air is jetted from jetting ports while causing swirling of the air. However, a large negative pressure can be generated only at the central portions of the jetting ports. Therefore, when a uniform suction force is desired for the entire non-contact transport apparatus, a huge number of jetting ports are required to be arranged without any gaps therebetween. Further, the sucked workpiece is rotated by the swirling air flow. Therefore, a structure must be provided such that a swirling flow in a direction opposite to that of the workpiece rotation is generated in order to inhibit rotation of the workpiece. As a result, the air flow passages become complicated, production costs are increased, and the apparatus consequently becomes large in size.

On the other hand, in the transport apparatus disclosed in Japanese Laid-Open Patent Publication No. 10-181879, when a large-sized sheet-shaped workpiece is transported, the gas guide surface, which constitutes the transport head, must be made large in size. However, forming the curved gas guide surface requires complicated processing. Further, the pressure distribution generated by the gas guide surface is not constant. Therefore, it is difficult to stably hold the workpiece without causing strain and/or warpage. When a plurality of transport heads are provided, the respective air flows that are discharged from adjoining heads collide with each other, making it impossible to generate a desired negative pressure, since air is directed radially outwardly from the transport heads.

### SUMMARY OF THE INVENTION

A general object of the present invention is to provide a non-contact transport apparatus which has a simple structure, and which makes it possible to stably hold and transport a thin large-sized workpiece in a non-contact manner.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an overall perspective view illustrating a non-contact transport apparatus according to a first embodiment of the present invention;

FIG. 2 is an exploded perspective view illustrating the non-contact transport apparatus shown in FIG. 1;

FIG. 3 is an overall perspective view illustrating the non-contact transport apparatus shown in FIG. 1, as viewed in another direction on a side of a top plate;

FIG. 4 is an exploded perspective view illustrating the non-contact transport apparatus shown in FIG. 3;

FIG. 5 is a plan view illustrating a single member depicting the top plate of the non-contact transport apparatus shown in FIG. 1;

FIG. 6 is a plan view illustrating a single member depicting a nozzle plate of the non-contact transport apparatus shown in FIG. 1;

FIG. 7 is a magnified perspective view illustrating elements disposed in the vicinity of a nozzle of the nozzle plate shown in FIG. 6;

FIG. 8 is a plan view illustrating a single member depicting a diffuser plate of the non-contact transport apparatus shown in FIG. 1;

FIG. 9 is a magnified plan view, with partial omission, illustrating the non-contact transport apparatus shown in FIG. 1;

FIG. 10 is a sectional view taken along line X-X shown in FIG. 9;

FIG. 11 is a sectional perspective view illustrating elements disposed in the vicinity of the nozzle and a discharge hole, which serve as an air flow passage;

FIG. 12 is a schematic exploded perspective view illustrating a modified embodiment of the non-contact transport apparatus, in which a nozzle is directly formed on one side surface of the top plate;

FIG. 13 is a schematic exploded perspective view illustrating another modified embodiment of the non-contact transport apparatus, in which a nozzle is directly formed on one side surface of the diffuser plate;

FIG. 14 is an overall perspective view illustrating a non-contact transport apparatus according to a second embodiment of the present invention;

FIG. 15 is an overall perspective view illustrating the non-contact transport apparatus shown in FIG. 14, as viewed in another direction on a side of a top plate;

FIG. 16 is an exploded perspective view illustrating the non-contact transport apparatus shown in FIG. 14; and

FIG. 17 is a sectional view taken along line XVII-XVII in FIG. 14.

### DESCRIPTION OF THE PREFERRED EMBODIMENTS

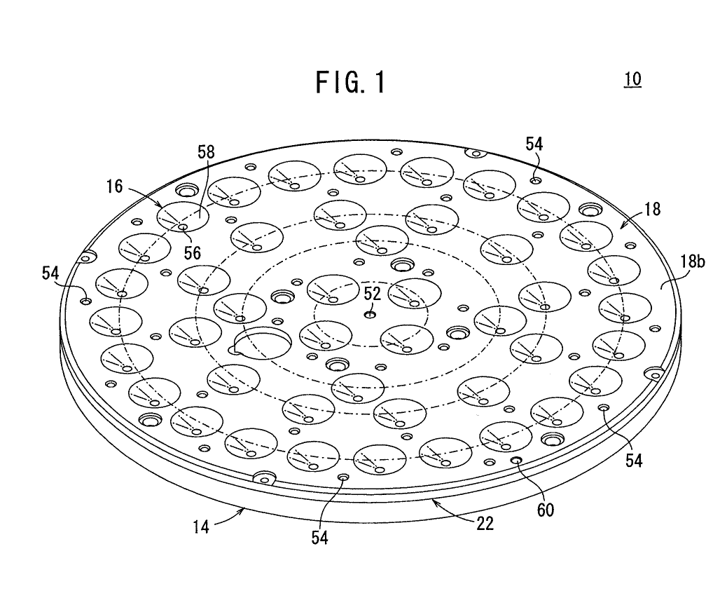

With reference to FIG. 1, reference numeral 10 indicates a non-contact transport apparatus according to a first embodiment of the present invention.

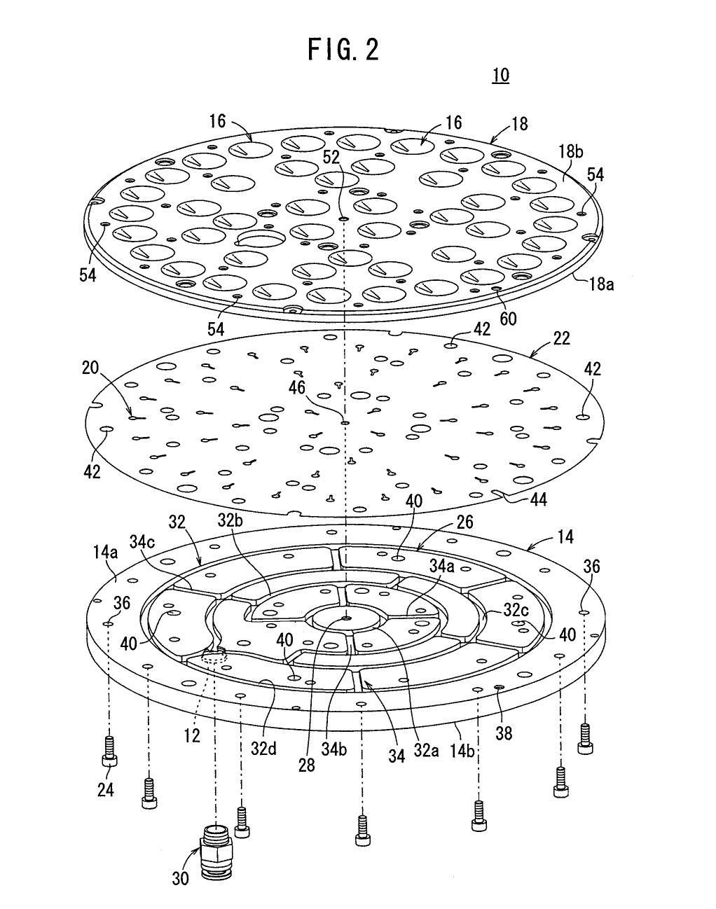

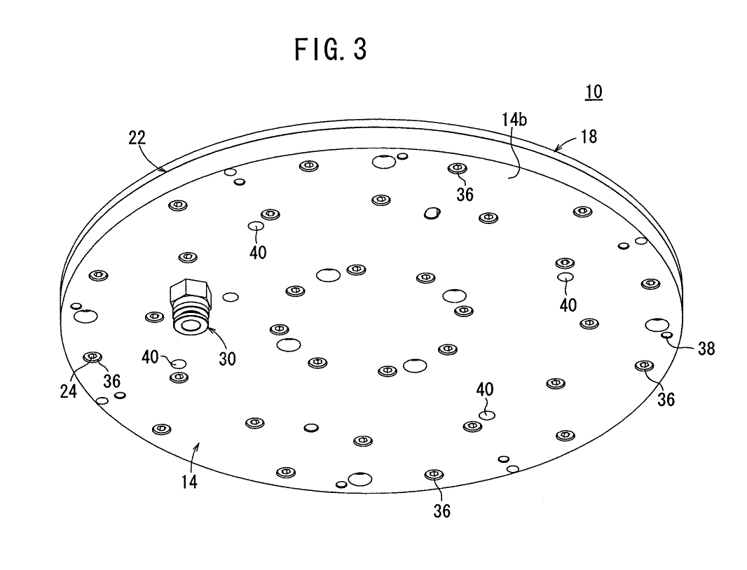

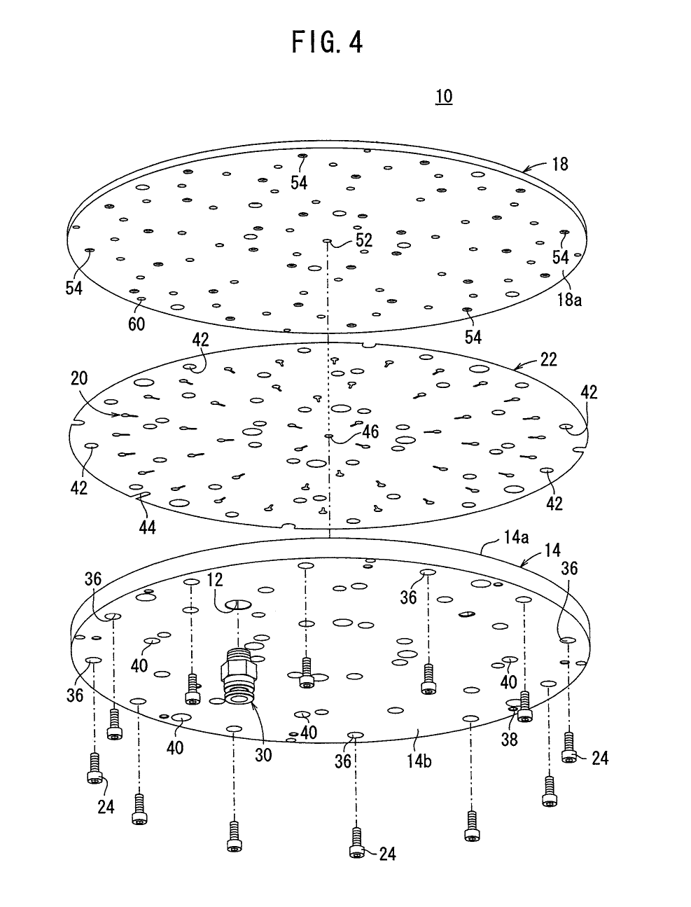

As shown in FIGS. 1 to 4, the non-contact transport apparatus 10 comprises a top plate 14 having a disk-shaped form, and which has a supply port (air supply section) 12 for supplying air thereto, a diffuser plate (under plate) 18 having a plurality of discharge holes (outlet holes) 16 for discharging air therefrom, a sheet-shaped nozzle plate (intermediate plate) 22 interposed between the top plate 14 and the diffuser plate 18, and which has a plurality of nozzles (guide passages) 20 therein, and a plurality of connecting bolts 24 that serve to fasten the stacked top plate 14, the nozzle plate 22, and the diffuser plate 18 integrally together.

The top plate 14 is formed, for example, from a resin material, or from a metal material such as an aluminum alloy. The top plate 14 is formed with flow passages 26 therein through which air flows. The flow passages 26 are formed on one side surface 14a, which faces the nozzle plate 22. The flow passages 26 communicate with the supply port 12. A first pin hole 28, into which an unillustrated positioning pin is inserted, is formed at a central portion of the top plate 14. The first pin hole 28 is oriented in a stacking direction defined by the top plate 14, the nozzle plate 22, and the diffuser plate 18.

A joint 30, which is connected to an unillustrated tube, is threaded into the supply port 12 on the other side surface 14b of the top plate 14. Air is supplied to the joint 30 via the tube from an air supply source (not shown). Accordingly, air is supplied to the flow passages 26 via the supply port 12.

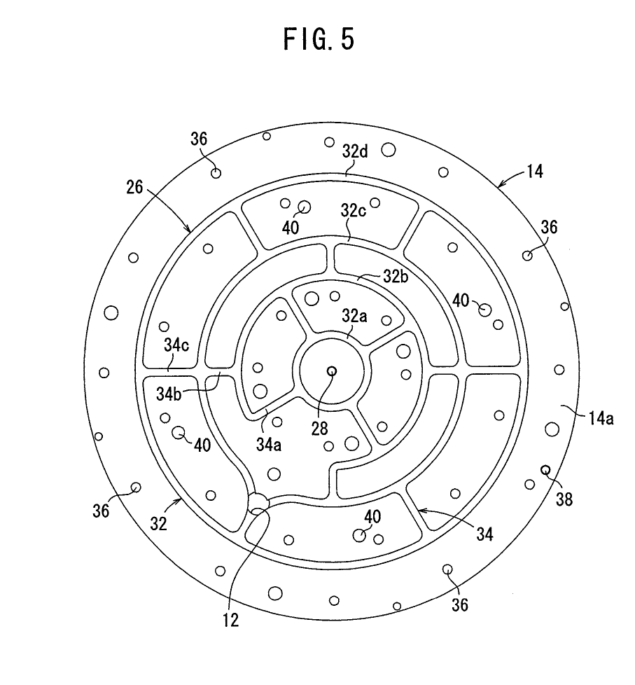

As shown in FIG. 5, the flow passages 26 include a plurality of annular passages 32, which are separated from each other by predetermined distances in a radially outward direction about the center of the first pin hole 28 of the top plate 14, and a plurality of radial passages 34, which interconnect the annular passages 32 with each other, and which are separated from each other by predetermined distances in the circumferential direction of the top plate 14. In the present arrangement, the annular passages 32 and the radial passages 34 are recessed a predetermined depth from one side surface 14a of the top plate 14, whereas the widthwise dimensions thereof are substantially constant.

The annular passages 32 include, for example, first to fourth annular passages 32a to 32d formed in this order in a radially outward direction from the center of the top plate 14.

On the other hand, the radial passages 34 include four first radial passages 34a connecting the first annular passage 32a and the second annular passage 32b to one another, four second radial passages 34b connecting the second annular passage 32b and the third annular passage 32c to one another, and four third radial passages 34c connecting the third annular passage 32c and the fourth annular passage 32d to one another. The supply port 12 is disposed at the portion where the third annular passage 32c intersects with the third radial passage 34c.

More specifically, air, which is supplied to the supply port 12, is supplied to the third annular passage 32c, whereupon the air is supplied to the fourth annular passage 32d via the third radial passage 34c. Air that is supplied to the third annular passage 32c flows into the second annular passage 32b via the second radial passage 34b. Then, the air is supplied to the first annular passage 32a from the second annular passage 32b via the first radial passage 34a.

A plurality of first bolt holes 36, into which connecting bolts 24 are inserted, are formed in the top plate 14, at positions disposed between the first to fourth annular passages 32a to 32d and the first to third radial passages 34a to 34c. Further, a second pin hole 38, into which a positioning pin (not shown) is inserted, is formed on an outer circumferential side of the top plate 14. The positioning pin is used, for example, to relatively position the top plate 14, the nozzle plate 22, and the diffuser plate 18 in the direction of rotation, when the top plate 14, the nozzle plate 22, and the diffuser plate 18 are stacked on one another and assembled in an integrated manner.

A plurality of attachment holes 40, into which attachment bolts (not shown) are inserted when the non-contact transport apparatus 10 is attached to another apparatus, are provided between the first bolt holes 36.

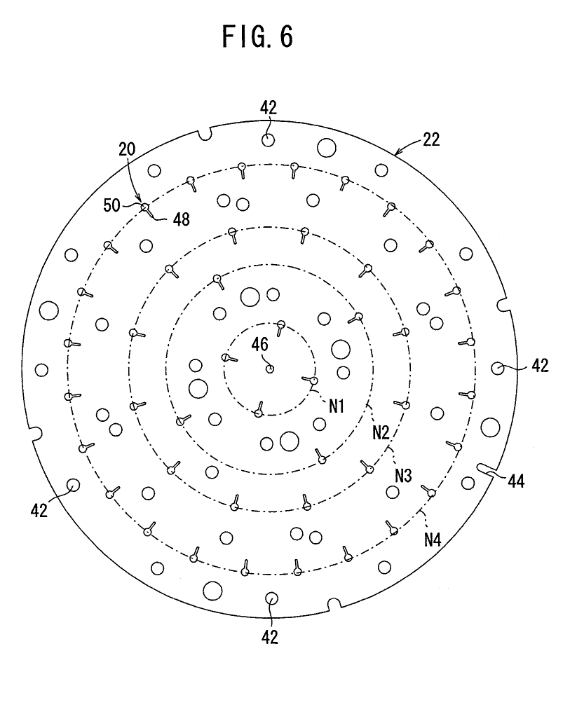

The nozzle plate 22 has, for example, a sheet-shaped form made of a metal material such as stainless steel. As shown in FIG. 6, the nozzle plate 22 includes a plurality of nozzles 20, which are arranged so as to oppose the flow passages 26 of the top plate 14, insertion holes 42 provided between the nozzles 20 and disposed so as to oppose the first bolt holes 36, wherein connecting bolts 24 are inserted into the first bolt holes 36, and a positioning groove 44, which is cut out from the outer circumferential surface extending toward an inner circumferential area of the nozzle plate 22. The thickness t of the nozzle plate 22 is preferably, for example, 0.05 to 0.1 mm (0.05≦t≦0.1) for sufficiently providing an ejector effect.

A hole 46, into which an unillustrated positioning pin is inserted, is formed at the center of the nozzle plate 22.

The plurality of nozzles 20 are radially disposed respectively, oriented in a radially outward direction from the hole 46, which forms the center of the nozzle plate 22. The nozzles 20 are arranged along predetermined radii in the circumferential direction. The nozzles 20 include a first nozzle array N1 arranged to face the first annular passage 32a of the top plate 14, a second nozzle array N2 arranged to face the second annular passage 32b, a third nozzle array N3 arranged to face the third annular passage 32c, and a fourth nozzle array N4 arranged to face the fourth annular passage 32d. More specifically, the first to fourth nozzle arrays N1 to N4 are arranged in this order in a radially outward direction from the center of the nozzle plate 22.

For example, each of the first and second nozzle arrays N1, N2 is composed of four nozzles 20, which are separated from each other by equal distances in the circumferential direction of the nozzle plate 22. The third nozzle array N3 is composed of twelve nozzles 20, which are separated from each other by equal distances, and the fourth nozzle array N4 is composed of twenty-four nozzles 20, which are separated from each other by equal distances.

The nozzles 20 making up the first nozzle array N1 and the nozzles 20 making up the second nozzle array N2 are arranged so that they are not aligned along a straight line in the radial direction of the nozzle plate 22. That is, the nozzles 20 of the first nozzle array N1 and the nozzles 20 of the second nozzle array N2 are deviated from each other in the circumferential direction, by predetermined angles with respect to the center of the nozzle plate 22. In other words, the nozzles 20 of the first nozzle array N1 are disposed circumferentially between the nozzles 20 of the second nozzle array N2.

Further, the nozzles 20 of the second nozzle array N2 and the third nozzle array N3 that lie adjacent to one another, and the nozzles 20 of the third nozzle array N3 and the fourth nozzle array N4, are arranged respectively so that they are not aligned along a straight line in the radial direction, in the same manner as described above. That is, all of the nozzles 20 making up the nozzle arrays N1 to N4, which lie adjacent to one another in the radial direction, are offset from each other by predetermined angles in the circumferential direction of the nozzle plate 22, and thus they are not aligned with each other along a straight line.

In other words, all of the nozzles 20 have mutually different directivities in the circumferential direction. With this arrangement, air can be guided or directed as a whole over the entire surface of the nozzle plate 22.

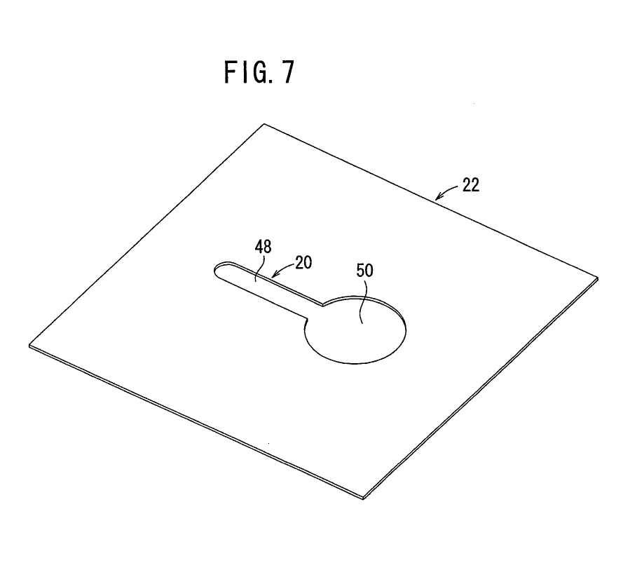

As shown in FIG. 7, each nozzle 20 is formed with a substantially keyhole-shaped form. The nozzle 20 includes an inlet section 48, which has a linear open shape with a narrow width disposed in a radially inward direction of the nozzle plate 22, and a substantially circular outlet section 50, which communicates with the inlet section 48 and is formed in a radially outward direction of the nozzle plate 22 with respect to the inlet section 48. The plurality of nozzles 20 are formed with substantially identical shapes, respectively.

The inlet section 48 has a predetermined length in the longitudinal direction. One end thereof faces the flow passage 26 of the top plate 14. On the other hand, the outlet section 50 is formed in a substantially circular shape with a predetermined radius, which is larger than the inlet section 48. The outlet section 50 is arranged so as to oppose the discharge hole 16 of the diffuser plate 18 that is stacked on the nozzle plate 22. That is, air that flows through the flow passage 26 of the top plate 14 also flows from the inlet section 48 along the nozzle 20, in a radially outward direction of the nozzle plate 22, whereupon the air passes through the outlet section 50 and is directed to the discharge hole 16 of the diffuser plate 18.

In this arrangement, the nozzle 20 is formed, for example, by laser processing or etching, which is applied to the sheet-shaped nozzle plate 22. Therefore, for example, even when the thickness of the nozzle plate 22 is several hundred μm, the nozzles 20 can be formed easily and highly accurately therein. When a large number of nozzles 20 are formed, such multiple nozzles 20 can be formed efficiently by means of etching. That is, since the non-contact transport apparatus 10 including the nozzle plate 22 is large in size, nozzles 20 can be formed more efficiently therein by means of etching.

A seal material composed of, for example, a rubber material is applied to both surfaces of the nozzle plate 22. The top plate 14 and the diffuser plate 18 are adhered respectively to the nozzle plate 22 by interposing the nozzle plate 22 between the top plate 14 and the diffuser plate 18. Accordingly, spaces between the nozzle plate 22, the top plate 14 and the diffuser plate 18 are airtightly sealed. Therefore, leakage of air to the outside is avoided.

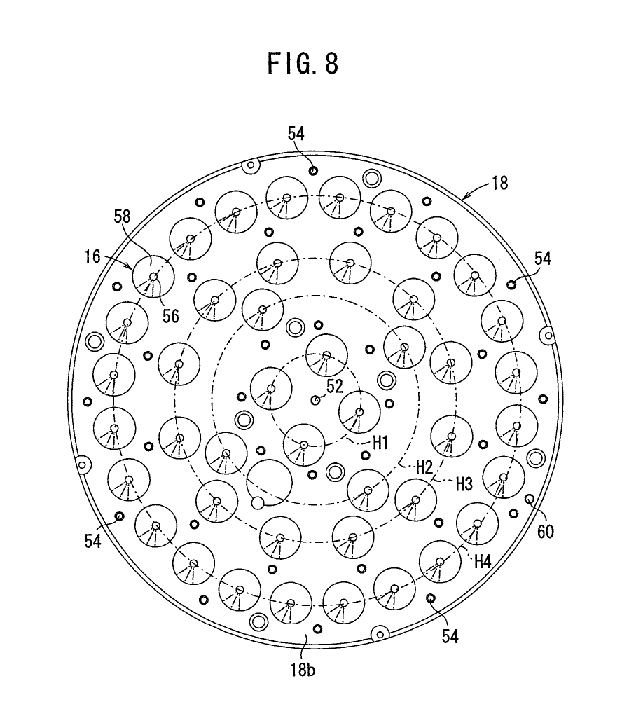

The diffuser plate 18 is formed, for example, from a resin material, or from a metal material such as an aluminum alloy. As shown in FIG. 8, the diffuser plate 18 has a plurality of discharge holes 16 therein to which air is supplied from the top plate 14, and from which air is discharged to the outside. A third pin hole 52, into which an unillustrated positioning pin is inserted, is formed at the center of the diffuser plate 18. The third pin hole 52 penetrates in the stacking direction through the top plate 14, the nozzle plate 22, and the diffuser plate 18.

The discharge holes 16 face the outlet sections 50 of the nozzles 20 of the nozzle plate 22. The discharge holes 16 are arranged on the diffuser plate 18 at predetermined radii in the circumferential direction. The discharge holes 16 include a first hole array H1 facing the nozzles 20 making up the first nozzle array N1 of the nozzle plate 22, a second hole array H2 facing the nozzles 20 of the second nozzle array N2, a third hole array H3 facing the nozzles 20 of the third nozzle array N3, and a fourth hole array H4 facing the nozzles 20 of the fourth nozzle array N4. Specifically, the first to fourth hole arrays H1 to H4 are arranged in this order, in a radially outward direction from the center of the nozzle plate 22.

A plurality of second bolt holes 54, in which the connecting bolts 24 are threaded, are formed between the respective discharge holes 16. Specifically, the top plate 14, the nozzle plate 22, and the diffuser plate 18 are stacked on each other, and then the connecting bolts 24 are inserted respectively into the first bolt holes 36 and the insertion holes 42 and threaded with the second bolt holes 54. Accordingly, the top plate 14, the nozzle plate 22, and the diffuser plate 18 are connected together in an integrated manner.

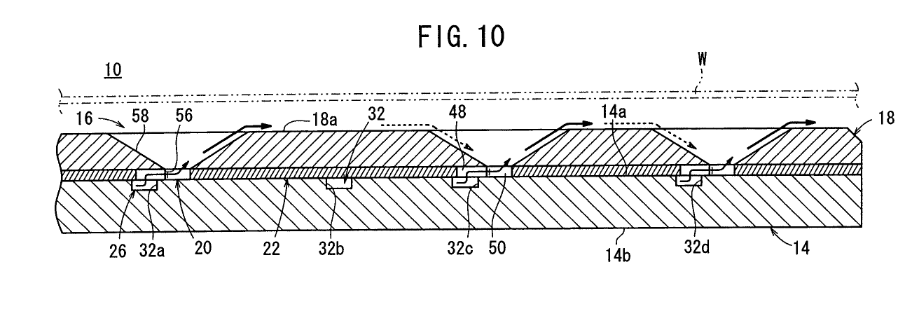

Further, the discharge hole 16 has an opening 56 formed on one side of the nozzle plate 22, disposed on one side surface 18a of the diffuser plate 18, and a tapered section 58 with diameters gradually increasing toward the other side surface 18b of the diffuser plate 18 away from the opening 56. The other side surface 18b of the diffuser plate 18 functions as a holding surface supporting the workpiece W (see FIG. 10).

The diameter of the opening 56 is substantially equivalent to the diameter of the inlet section 48, which constitutes the nozzle 20. The discharge hole 16 and the nozzle 20 communicate with each other via the opening 56. A plurality of discharge holes 16 are formed having substantially the same shape, respectively, wherein the number of discharge holes 16 equals the number of nozzles 20.

The tapered section 58 is formed, for example, by drill processing, such that the diameters thereof increase at a predetermined angle (for example, 120°) about the axial center of the opening 56. In other words, the tapered section 58 has a mortar-shaped form, such that the discharge hole 16, including tapered section 58, is annular with respect to the diffuser plate 18.

A fourth pin hole 60, for insertion of an unillustrated positioning pin, is formed on the outer circumferential side of the diffuser plate 18. More specifically, one positioning pin is inserted through the first pin hole 28, the hole 46, and the third pin hole 52, which are formed centrally in the respective plates, so as to adjust the centers of the top plate 14, the nozzle plate 22, and the diffuser plate 18, whereas another positioning pin is inserted through the second pin hole 38, the positioning groove 44, and the fourth pin hole 60. Accordingly, the top plate 14, the nozzle plate 22, and the diffuser plate 18 are relatively positioned in the direction of rotation.

Accordingly, an integral assembly can be provided, in which centers of the top plate 14, the nozzle plate 22 and the diffuser plate 18 are coincident with each other, and wherein the nozzles 20 of the nozzle plate 22 and the discharge holes 16 of the diffuser plate 18 are opposed to each other.

The foregoing explanation concerns a case in which the top plate 14, the nozzle plate 22, and the diffuser plate 18 are integrally fastened together by a plurality of connecting bolts 24. However, the invention is not limited to such a feature. For example, a top plate 14, a nozzle plate 22, and a diffuser plate 18, each of which is composed of a metal material, may also be integrally connected to one another by means of diffusion joining.

More specifically, the top plate 14, the nozzle plate 22, and the diffuser plate 18 are positioned so as to overlap one another, and then the components are mutually pressurized and heated. Accordingly, mutual diffusion arises at the contact portions so as to effect joining. In this case, the plurality of connecting bolts 24 becomes unnecessary and the number of parts can be reduced.

The first bolt holes 36 in the top plate 14 have respective thicknesses in which the heads of the connecting bolts 24 are accommodated. However, if the connecting bolts 24 are not used, then the first bolt holes 36 can be dispensed with, whereby the thickness of the top plate 14 can be reduced. Further, the second bolt holes 54 in the diffuser plate 18 also become unnecessary, so it is also possible to reduce the thickness of the diffuser plate 18 as well. As a result, a thin-sized non-contact transport apparatus 10, still including the top plate 14 and the diffuser plate 18, can be realized.

The non-contact transport apparatus 10 according to the first embodiment of the present invention is basically constructed as described above. Next, operations, functions and effects thereof shall be explained.

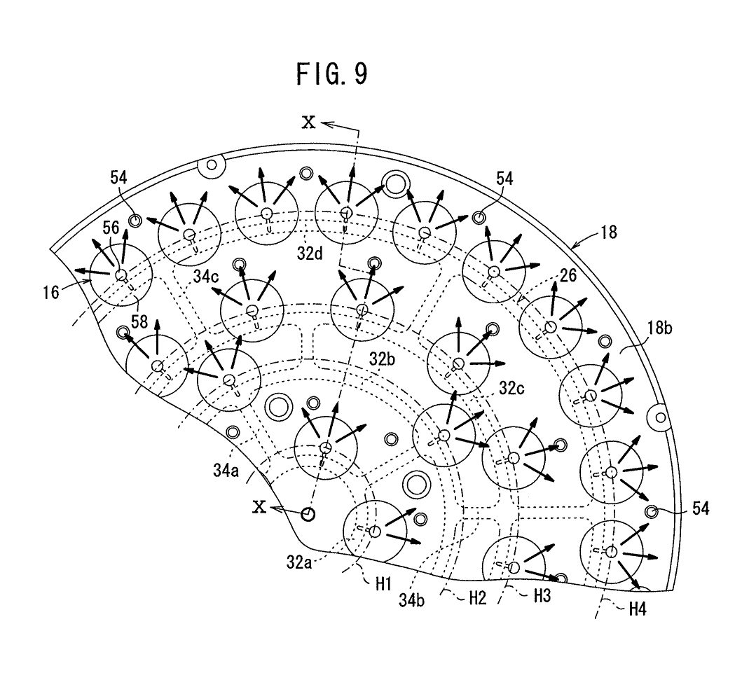

Air is supplied from an unillustrated air supply source via the joint 30 to the supply port 12. As shown in FIGS. 9 and 10, air that is supplied to the supply port 12 is supplied in turn to the first to fourth annular passages 32a to 32d, which make up the flow passages 26, and via the third annular passage 32c and the third radial passage 34c of the top plate 14 that communicate with the supply port 12. Air is introduced into the inlet sections 48 of the plural nozzles 20, which face the first to fourth annular passages 32a to 32d. The air flows through the respective nozzles 20 toward the outlet sections 50.

In this situation, the nozzles 20 are formed radially, and are directed in a radially outward direction about the center of the hole 46 of the nozzle plate 22. Therefore, air flows from the inlet sections 48 toward the outlet sections 50 of the respective nozzles 20, wherein the air then flows radially in a radially outward direction. The cross-sectional passage area of the nozzles 20, through which the air flows, is determined by the minute thickness dimension of the nozzle plate 22, as well as the widthwise dimension of the inlet section 48.

Therefore, air flows through a minute space, surrounded by a side surface 14a of the top plate 14, a side surface 18a of the diffuser plate 18, and the inner wall surface of the nozzle 20. Accordingly, the air flow velocity through the nozzle 20 is increased, whereby a negative pressure is generated.

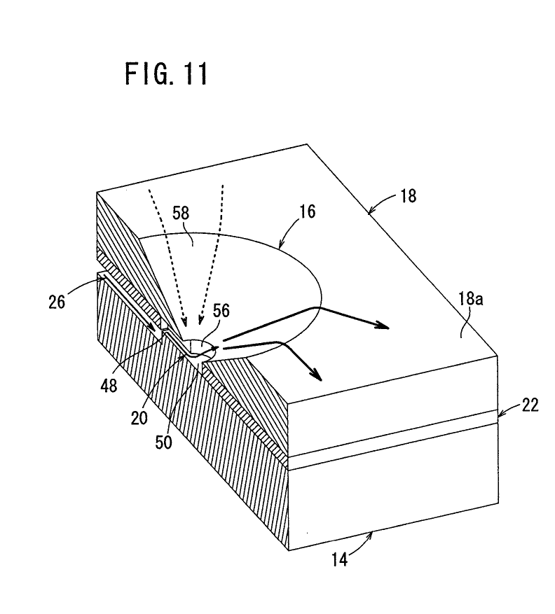

Air flows from the outlet sections 50 of the nozzles 20, via the opening 56 of the diffuser plate 18, and to the discharge hole 16. Air is then directed to the outside along the tapered section 58 of the discharge hole 16. In this situation, the air flows in a radially outward direction of the diffuser plate 18, and along the tapered sections 58 of the discharge holes 16, respectively. Air thus flows in a radial form along the other side surface 18b (holding surface), so as to move away from the center of the diffuser plate 18 (see FIGS. 10 and 11). Specifically, air is directed from the discharge holes 16, and then the air flows in an identical direction, so as to be directed radially outwardly from the center side of the diffuser plate 18.

As shown in FIGS. 9 and 11, air that is directed from the discharge holes 16 flows in such a way that the flow thereof becomes widened at a predetermined angle along the tapered section 58 from the opening 56. The air directed from the discharge holes 16 has a flow velocity, which is gradually lowered by resistance, as the air progressively flows radially outwardly. The air directed from the discharge hole 16 of the first hole array H1, which is disposed on the innermost circumferential side of the diffuser plate 18, flows along the other side surface 18b. A portion of such air is guided toward the discharge hole 16 of the adjoining second hole array H2, wherein the discharge hole 16 has a mortar shape with an annular tapered section 58. Therefore, air is appropriately guided by the tapered section 58, as a result of an ejector effect caused within the discharge hole 16.

More specifically, air that is directed from the discharge holes 16 of the first hole array H1 is guided into the discharge holes 16 of the second hole array H2. Accordingly, such air is redirected to the outside as a result of the air that is directed from the discharge holes 16 of the second hole array H2. Accordingly, air directed from the discharge holes 16 of the first hole array H1, is directed together with air directed from the discharge holes 16 of the second hole array H2, whereby the air flows along the other side surface 18b. Further, the flow velocity of the decelerated air achieves a desired flow velocity, which is maintained substantially constant. As a result, desired performance of the non-contact transport apparatus 10 can be satisfied using a smaller amount of air. In other words, the amount of air consumed by the non-contact transport apparatus 10 can be reduced.

Similarly, air directed from the discharge holes 16 of the second hole array H2 and the discharge holes 16 of the third hole array H3 is successively guided into the discharge holes 16 of the third and fourth hole arrays H3 and H4, which are disposed adjacently and radially outwardly, respectively. Accordingly, air flow velocity is maintained substantially constant. Therefore, the flow velocity of air that flows radially outwardly along the diffuser plate 18 is kept substantially constant.

Accordingly, when air is directed from the plurality of discharge holes 16 formed on the diffuser plate 18, a workpiece W (for example, a wafer), which is arranged at a position opposed to the diffuser plate 18, is attracted by the negative pressure generated by the nozzles 20. On the other hand, a repulsive force is exerted by the air (positive pressure) that intervenes between the diffuser plate 18 and the workpiece W. Thus, the workpiece W is held in a non-contact state as a result of a balance between such negative and positive pressures. As a result, the workpiece W can be transported to a predetermined position, in a state in which the workpiece W is held by the other side surface 18b that forms the holding surface of the diffuser plate 18.

The positive and negative pressures acting on the workpiece W are changed depending on a clearance between the diffuser plate 18 and the workpiece W. More specifically, when such a clearance is decreased, the negative pressure decreases whereas the positive pressure increases. On the other hand, when such a clearance is increased, the negative pressure increases whereas the positive pressure decreases. In this case, the lifted workpiece W provides an optimum clearance, in accordance with a balancing of the weight of the workpiece W itself, and the positive and negative pressures. Therefore, for example, a wafer or a flexible film-shaped workpiece W can be transported without inducing warpage or strain in the workpiece.

As described above, according to the first embodiment, the top plate 14 having flow passages 26 for supplying air thereto is provided, together with the diffuser plate 18 with discharge holes 16 therein for directing air toward the outside, and the nozzle plate 22 having nozzles 20 therein communicating between the flow passages 26 and the discharge holes 16. The nozzles 20 are disposed radially in the nozzle plate 22, such that the nozzles 20 communicate on an inner circumferential side thereof with the flow passages 26. Further, the nozzles 20 communicate on an outer circumferential side thereof with the discharge holes 16. Accordingly, air supplied from the flow passages 26 to the nozzles 20 successfully flows in a radially outward direction, whereby the air flows in such a radially outward direction through the discharge holes 16 and along the holding surface of the diffuser plate 18.

The plural discharge holes 16 are arranged so as to be offset at predetermined angles from each other, so that the discharge holes 16 are not aligned along a straight line in the radial direction of the diffuser plate 18. Air directed out from the discharge holes 16 that are arranged on the inner circumferential side is guided toward the other discharge holes 16, provided adjacent thereto on the outer circumferential side. Such air flows again in a radially outward direction, together with air directed from the discharge holes 16.

Specifically, air that has been lowered in flow velocity, after having been directed from the inner circumferential side of the diffuser plate 18, is guided toward the discharge holes 16 provided on the outer circumferential side thereof. Accordingly, a substantially constant flow velocity can be maintained utilizing the air directed from the discharge holes 16. As a result, the flow velocity of the air that flows along the other side surface 18b of the diffuser plate 18 is maintained substantially constant over the entire region of the other side surface 18b, as a result of the air that is directed out from the plurality of discharge holes 16.

Accordingly, the flow direction of the air that flows along the holding surface holding the workpiece W can be made identical, while the flow velocity thereof can be maintained substantially constant. Therefore, between the workpiece W and the holding surface, a relationship between the air and the negative pressure is appropriately maintained. Thus, a substantially constant clearance between the workpiece W and the holding surface can be maintained.

As a result, the sheet-shaped workpiece W can be held stably without causing warpage, in a state such that the workpiece W makes no contact with the holding surface, owing to the Bernoulli effect. Even when a large-sized workpiece W is transported, the workpiece W can be transported while being held stably.

The nozzle plate 22 has an extremely thin sheet-shaped form in relation to the thickness dimension thereof. Therefore, the overall thickness of the non-contact transport apparatus 10, including the nozzle plate 22, is suppressed. Thus, a thin non-contact transport apparatus 10 can be provided.

The number of nozzle plates 22 interposed between the top plate 14 and the diffuser plate 18 may be increased or decreased. Further, the nozzles 20 of the respective nozzle plates 22 may have different shapes. Accordingly, the passage cross-sectional area of the nozzle 20 through which the air flows can be adjusted arbitrarily. Therefore, the flow rate of air that flows through the nozzles 20 from the flow passages 26 of the top plate 14 and toward the discharge holes 16 of the diffuser plate 18 can be controlled appropriately. The air can be regulated so as to achieve a desired flow rate depending on, for example, the weight, outer diameter, and/or the shape of the workpiece W.

By forming the nozzles 20 by means of etching applied to the sheet-shaped nozzle plate 22, the shape of the nozzles 20 can be formed easily and highly accurately. Accordingly, it is easy to manage the dimensional accuracy of the nozzles 20 as well.

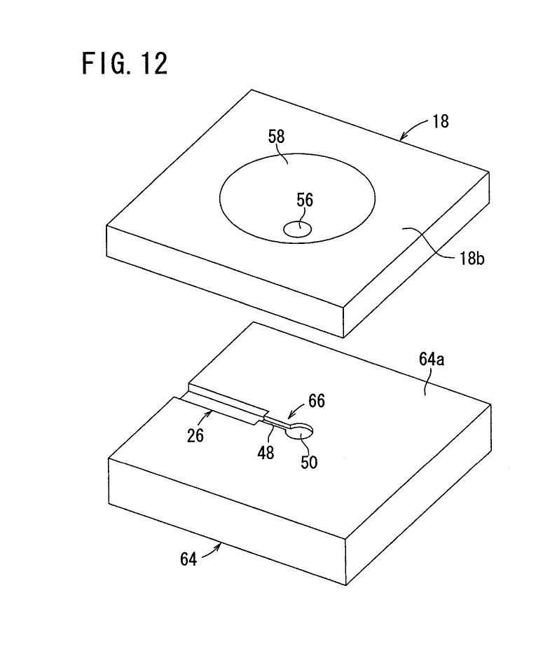

On the other hand, as shown in FIG. 12, nozzles 66 may be formed directly, for example, by means of a cutting process, such that communication is established with the flow passages 26, with respect to one side surface 64a of a top plate 64, and without providing a plurality of nozzle plates 22.

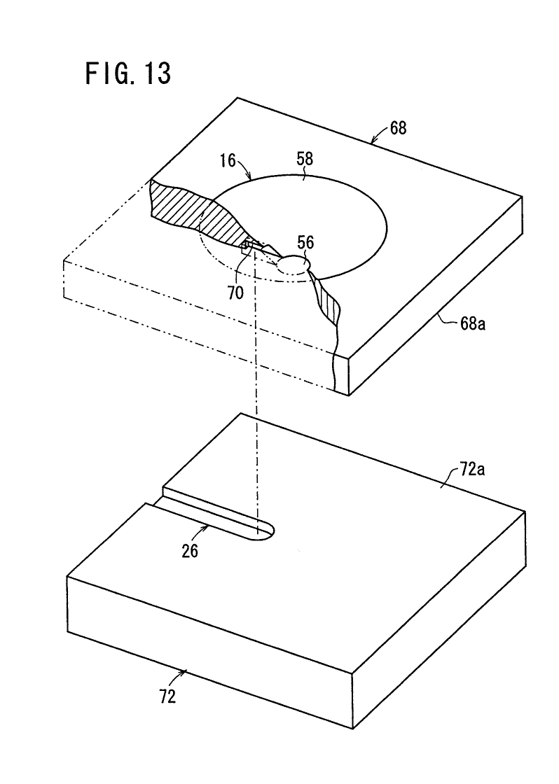

Further, on the contrary, as shown in FIG. 13, the nozzles 70 may be directly formed so as to communicate with the openings 56 of the discharge holes 16 with respect to one side surface 68a of the diffuser plate 68, wherein flow passages 26 facing the nozzles 70 are provided on one side surface 72a of a top plate 72. Accordingly, a non-contact transport apparatus 10 can be manufactured, even when processing cannot be performed on the nozzles by means of etching, for example. Further, in this case, the nozzle plate 22 becomes unnecessary, and thus the number of parts and assembly steps can be reduced.

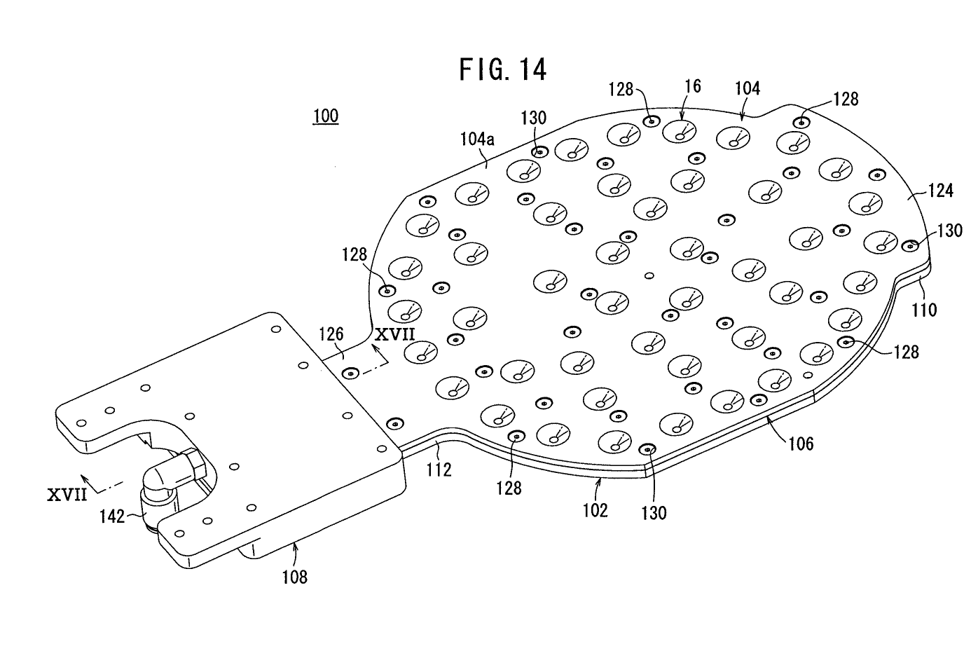

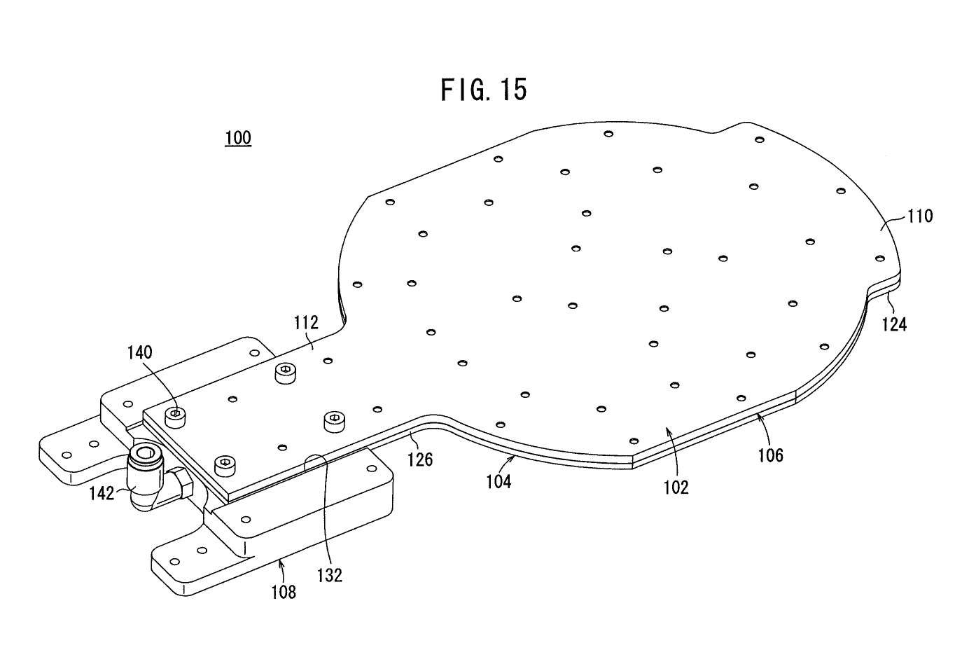

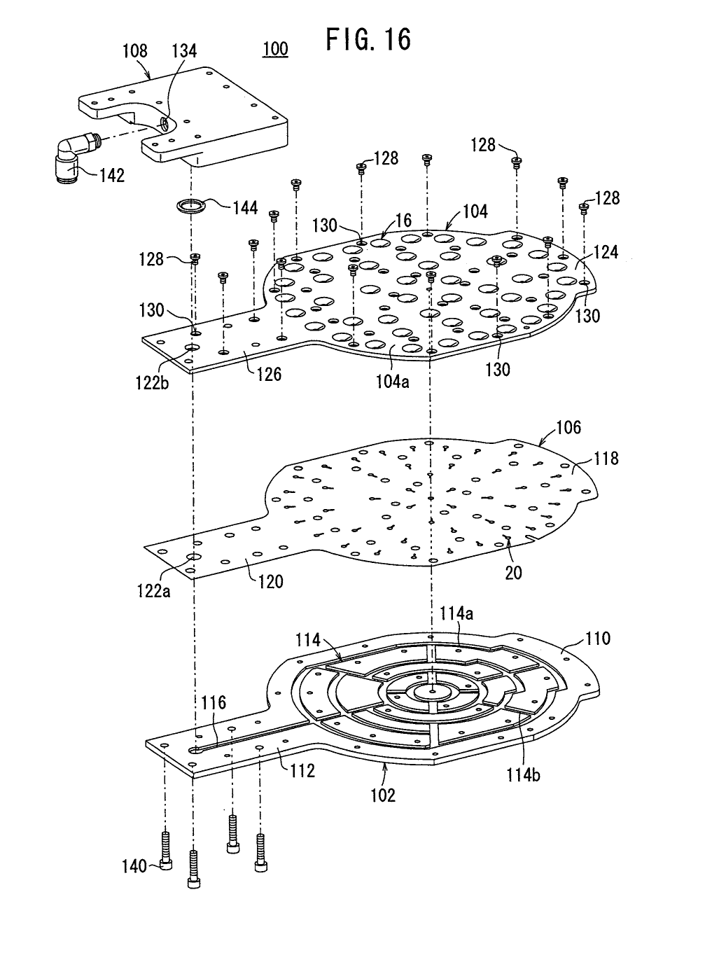

Next, a non-contact transport apparatus 100 according to a second embodiment is shown in FIGS. 14 to 17. Constitutive components thereof, which are the same as those of the non-contact transport apparatus 10 according to the first embodiment of the present invention, shall be designated using the same reference numerals, and detailed explanations of such features shall be omitted.

As shown in FIGS. 14 to 17, the non-contact transport apparatus 100 according to the second embodiment differs from the non-contact transport apparatus 10 of the first embodiment in that a top plate 102, a diffuser plate (under plate) 104, and a nozzle plate (intermediate plate) 106 are formed in substantially elliptical shapes, respectively, and a connecting block 108, which can be connected to an unillustrated transport apparatus, for example, is connected to ends of the top plate 102, the diffuser plate 104, and the nozzle plate 106.

A first projection 110 protruding a predetermined length is formed on one end of the top plate 102. A first connecting section 112, extending in a direction away from the first projection 110, is formed at the other end. The first projection 110 and the first connecting section 112 are disposed along a straight line.

Flow passages 114, which face the nozzle plate 106, are formed in the top plate 102. The flow passages 114 communicate with a communication passage 116 formed along the first connecting section 112. The flow passages 114 are made up of a plurality of annular passages 114a, and radial passages 114b, which connect the annular passages 114a to one another. The flow passages 114 are constructed in substantially the same manner as those of the non-contact transport apparatus 10 of the first embodiment, and thus detailed explanations of the flow passages 114 shall be omitted.

The nozzle plate 106 has approximately the same shape as the top plate 102. A second projection 118 formed at one end thereof overlaps with the first projection 110 of the top plate 102. On the other hand, a second connecting section 120 formed at the other end of the nozzle plate 106 overlaps with the first connecting section 112 of the top plate 102. A communication hole 122a, which faces one end of the communication passage 116 formed in the top plate 102, is formed in the second connecting section 120. The nozzle plate 106 includes a plurality of nozzles 20, which are arranged at positions facing the flow passages 114 of the top plate 102. The shapes and arrangement of the nozzles 20 are substantially the same as those of the non-contact transport apparatus 10 of the first embodiment, and thus detailed explanation of the nozzles 20 shall be omitted.

The diffuser plate 104 has approximately the same shape as the top plate 102 and the nozzle plate 106. A third projection 124 formed at one end thereof overlaps with the first and second projections 110, 118. A third connecting section 126 formed at the other end thereof overlaps with the first and second connecting sections 112, 120. A plurality of bolts 128 are inserted into bolt holes 130, from the side of the diffuser plate 104 and toward the side of the top plate 102. The diffuser plate 104, the nozzle plate 106, and the top plate 102 are connected in an integrated manner by means of the bolts 128.

A communication hole 122b, facing the communication passage 116 of the top plate 102 and the communication hole 122a of the nozzle plate 106, is formed in the third connecting section 126. More specifically, the communication passage 116 of the top plate 102 communicates with the communication holes 122a, 122b of the nozzle plate 106 and the diffuser plate 104.

A plurality of discharge holes 16 are arranged between the bolt holes 130 in the diffuser plate 104. The discharge holes 16 are arranged at positions facing the nozzles 20 of the nozzle plate 106, respectively.

The connecting block 108 is formed in a block-shaped configuration from a metal material. The connecting block 108 includes a recess 132, which is connected to the third connecting section 126 of the diffuser plate 104, a supply port (air supply section) 134 opening on a side surface perpendicular to the recess 132, and a passage 138 through which the supply port 134 communicates with an opening 136 on one side of the recess 132.

The connecting block 108 is connected to the third connecting section 126 of the diffuser plate 104 by connecting bolts 140, such that the top plate 102, the diffuser plate 104, and the nozzle plate 106 are stacked.

The supply port 134 opens in a direction away from the top plate 102, the diffuser plate 104 and the nozzle plate 106. A joint 142 connected to an unillustrated tube is threaded with the nozzle plate 106. Air is supplied to the joint 142 via the tube from an air supply source (not shown).

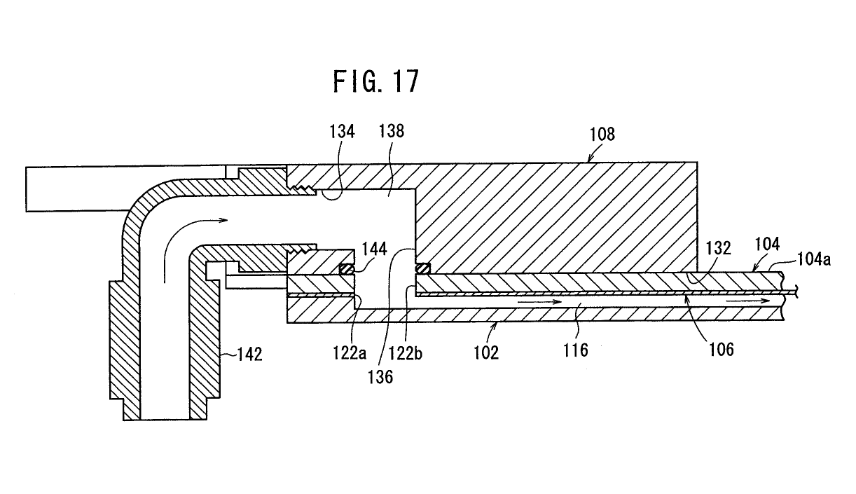

As shown in FIG. 17, the passage 138 connects with the supply port 134 and the opening 136 substantially perpendicularly, such that the opening 136 is positioned in opposition to the communication hole 122b of the diffuser plate 104. Accordingly, air supplied from the supply port 134 is supplied to the communication passage 116 of the top plate 102 via the passage 138 and the communication holes 122a, 122b, whereby the air is then guided from the communication passage 116 to the flow passage 114.

An O-ring 144 is installed in an annular groove at the opening 136 of the passage 138. The O-ring 144 maintains an airtight state between the connecting block 108 and the diffuser plate 104.

In the non-contact transport apparatus 100, air supplied via the joint 142 to the supply port 134 is guided to the flow passages 114 via the communication passage 116 of the top plate 102. Air is discharged through the discharge holes 16 of the diffuser plate 104 from the flow passages 114 via the nozzles 20. Accordingly, air flows radially in identical directions along the diffuser plate 104. Thus, a substantially constant clearance between an unillustrated workpiece and the holding surface 104a of the diffuser plate 104 can be maintained.

More specifically, in the non-contact transport apparatus 100 according to the second embodiment, the widthwise dimensions of the top plate 102, the diffuser plate 104, and the nozzle plate 106 are smaller compared to the disk-shaped non-contact transport apparatus 10 of the first embodiment. Therefore, even when the transport space for the workpiece that is transported by the non-contact transport apparatus 100 is a narrow space, the non-contact transport apparatus 100 can still be inserted and disposed at a desired position so that the workpiece can be reliably transported.

When the connecting block 108 is provided at one end of the non-contact transport apparatus 100 and is attached, for example, to a transport apparatus such as a robot arm, the non-contact transport apparatus 100 can be moved conveniently. Therefore, the workpiece can be freely transported. Further, in this arrangement, the supply port 134 is provided in the connecting block 108 that is disposed at the end of the non-contact transport apparatus 100. Therefore, attachment/detachment operations can be conveniently performed, with respect to a tube (not shown) that is connected to the supply port 134 via the joint 142. Thus, maintenance of the non-contact transport apparatus 100 can be performed satisfactorily.

Although certain preferred embodiments of the present invention have been shown and described in detail, it should be understood that various changes and modifications may be made therein without departing from the scope of the appended claims.

What is claimed is:

1. A non-contact transport apparatus comprising:
a top plate having an air supply section and flow passages that permit air to flow therethrough, wherein said air is supplied via said air supply section;
an under plate connected to said top plate and having a plurality of outlet holes for discharging said air; and
a guide mechanism provided between said top plate and said under plate and communicating with said flow passages and said outlet holes, wherein said guide mechanism guides said air radially outwardly in relation to said top plate and said under plate, thereby generating a negative pressure as a result of a flowing action of said air.

2. The non-contact transport apparatus according to claim 1, wherein said guide mechanism comprises an intermediate plate interposed between said top plate and said under plate, said guide mechanism having a plurality of guide passages extending in a radial form radially outwardly from a center of said intermediate plate.

3. The non-contact transport apparatus according to claim 2, wherein said guide passage has one end disposed on a center side of said intermediate plate that communicates with said flow passage, and another end disposed on a radially outer side of said intermediate plate that communicates with said outlet hole.

4. The non-contact transport apparatus according to claim 3, wherein a cross-sectional area of said guide passage is smaller than a cross-sectional area of said flow passage.

5. The non-contact transport apparatus according to claim 3, wherein a plurality of said intermediate plates are interposed between said top plate and said under plate, said guide passages having different shapes respectively in said plurality of said intermediate plates.

6. The non-contact transport apparatus according to claim 1, wherein said outlet hole comprises a tapered section with diameters gradually increasing in a direction away from said flow passage of said top plate, said air flowing along said tapered section.

7. The non-contact transport apparatus according to claim 6, wherein said outlet holes are separated from each other by predetermined distances on said under plate.

8. The non-contact transport apparatus according to claim 1, wherein said guide mechanism is disposed on a side surface of said top plate opposed to said under plate, or on a side surface of said under plate opposed to said top plate.

9. The non-contact transport apparatus according to claim 1, wherein said top plate and said under plate are integrally connected to one another through connecting bolts.

10. The non-contact transport apparatus according to claim 1, wherein said top plate and said under plate are connected to one another by means of diffusion joining.

11. The non-contact transport apparatus according to claim 3, wherein said top plate, said under plate and said intermediate plate are connected to one another by means of diffusion joining.

12. The non-contact transport apparatus according to claim 3, wherein said top plate, said under plate and said intermediate plate have elliptical cross-sectional shapes respectively.
